(19) United States
(12) Patent Application Publication
(10) Pub. No.: US 2014/0143464 A1
(43) Pub. Date: May 22, 2014

(54) SAS EXPANDER

(71) Applicants: Balaji Natrajan, Spring, TX (US); Michael G. Myrah, Cypress, TX (US); Joseph David Black, Houston, TX (US)

(72) Inventors: Balaji Natrajan, Spring, TX (US); Michael G. Myrah, Cypress, TX (US); Joseph David Black, Houston, TX (US)

(73) Assignee: HEWLETT-PACKARD DEVELOPMENT COMPANY, L.P., Houston, TX (US)

(21) Appl. No.: 14/130,947

(22) PCT Filed: Sep. 21, 2011
(86) PCT No.: PCT/US2011/052643

§ 371 Date: Jan. 6, 2014

(51) Int. Cl. G06F 13/372

(52) U.S. Cl. CPC G06F 13/372
USPC 710/117

(57) ABSTRACT

A SAS expander includes a receiver module, a timer module and an arbitration module. The receiver module is to receive initiator requests which include initiator wait time values and specify requested targets. The timer module has timers to generate total wait time values representing length or time the initiators having been waiting for the specified requested targets. The timers are to be initialized with wait time values comprising the initiator request wait time values and user-defined wait time values. The arbitration module is to select an initiator request having the highest total wait time value from among the initiator requests requesting the same targets.

### BACKGROUND

Serial attached small computer system interface (SAS) is a communications protocol for enabling communications between computer devices. In the SAS protocol, SAS devices include initiator devices, target devices, and expander devices. Initiator devices are devices that begin a SAS data transfer, while target devices are devices to which initiator devices transfer data. Expander devices are devices that facilitate data transfer between multiple initiator devices and multiple target devices. The SAS protocol utilizes a point-to-point bus topology. Therefore, if an initiator device is required to connect to multiple target devices, a direct connection can be established between the initiator device and each individual target device to facilitate each individual data transfer between the initator device and each individual target device. Expander devices can manage the connections and data transfer between multiple initiator devices and multiple target devices. A SAS fabric can include a network of initiator devices, target devices and expander devices.

### BRIEF DESCRIPTION OF THE DRAWINGS

Certain examples are described in the following detailed description and in reference to the drawings, in which:

FIG. 1 is an example block diagram of a SAS expander;

FIG. 2 is an example process flow diagram of a method of operating a SAS expander; and

FIG. 3 is an example block diagram showing a non-transitory, computer-readable medium that stores instructions for operating a SAS expander.

### DETAILED DESCRIPTION OF SPECIFIC EXAMPLES

A explained above, a SAS fabric can include a network of initiator devices, target devices and expander devices. In a SAS fabric, it may be desirable to specify which initiator devices are considered high priority and which initiator devices are considered low priority. For instance, a SAS fabric can comprise server computers configured as initiator devices and storage resource such as storage subsystems configured as target devices. The user may desire to specify that a server computer used for backup be low priority and that another server that is customer facing, for instance database access be higher priority. The initiators of the servers may be part of the same SAS fabric and share the same resources of the fabric such as expanders.

As explained below in further detail, some example of the present application may provide a SAS fabric priority technique to allow a user to assign priorities to particular initiators which may result in better quality of service for higher priority initiators. This may be important because bottlenecks may develop on a SAS fabric when many initiators are involved. The user may have knowledge that certain initiators are low priority. For instance, as backup application may be low priority whereas storage used to implement a front end website may be high priority. In one example of the present application, the priority technique may allow particular initiators to be assigned higher priority such that requests from these higher priority initiators may be routed through the SAS fabric more often than lower priority requests. Further, this priority technique can achieve this without completely starving out lower priority initiators.

In one example of the present application, described is a SAS expander configured to allow users to set priorities for initiators in the fabric. The expander may allow a user to specify user-defined wait time values to particular initiator requests such that the expander can give higher priority to requests with the highest wait times. The user-defined wait time values can be associated with ports of an expander which receive the initiator requests. In this manner, the expander may include an arbitration process that can give initiators with higher wait time values higher priority over initiators with lower wait time values when contending for the same target resources. Further, the priorities and corresponding wait time values may be maintained by the expander which may reduce the need to make changes to the initiators and target devices.

In one example of the present application, described is a SAS expander that includes a receiver module, a timer module and an arbitration module. The receiver module can receive initiator requests which can include initiator wait time values and specify requested targets. The timer module may include timers which can generate total wait time values representing length of time the initiators having been waiting for the specified requested targets. The timers can be initialized with wait time values that include the initiator request wait time values and user-defined wait time values. The arbitration module can then select an initiator request having the highest total wait time value from among the initiator requests requesting the same targets. Thus, the expander may allow a user to assign priorities to initiators and then select the initiator with the highest priority having the highest total wait time from initiators requesting for the same target.

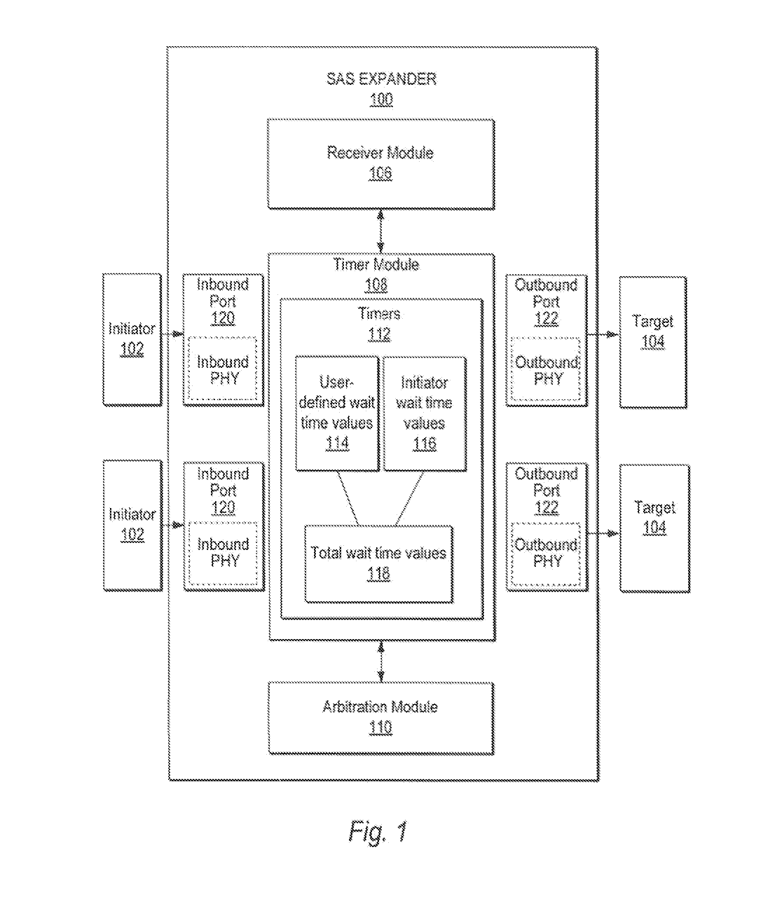

FIG. 1 is an example block diagram of a SAS fabric. The SAS fabric may include an interconnection of SAS protocol enabled devices including an expander 100 capable of coupling initiators 102 with targets 104.

The initiators 102 may include any data processing device capable of generating requests for exchanging data with other devices on the fabric. The initiators 102 are capable of generating multiple requests directed to storage resources associated with multiple targets 104. Initiators 102 may comprise server computers with array controllers to enable the servers to access and communicate with other devices on the SAS fabric. The array controllers can comprise storage controllers such as disk army controllers which can manage physical disk drives and can present them to the servers as logical units. In some examples, array controllers can implement redundant array of independent disks (RAID) functionality and may be referred to as RAID controllers.

The targets 104 may include any data processing device capable of managing storage resources with functionality for storage of data and for subsequent retrieval by initiators 102. For example, targets 104 may include storage drive bays which may or may not contain storage drives, such as disk drives, sod state drives, and the like.

The expander 100 is shown as inc ding an inbound port 120, outbound port 122, a receiver module 106, a timer module 108 and an arbitration module 110.

The inbound port 120 can include a SAS interface for providing a connection between initiators 102 and expander 100. The inbound port 120 can include one or more inbound PHYs which can comprise SAS protocol structures with transceivers for exchanging data and requests or commands between initiators 102 and expander 100. In a similar manner, outbound port 122 can include a SAS interface for providing a connection between targets 104 and expander 100. The outbound port 122 can include one or more outbound PHYs which can comprise SAS protocol structures with transceivers for exchanging data and requests or commands between targets 104 and expander 100. The expander 100 may include en inbound table that maps inbound PHYs of inbound port 120 with corresponding initiators 102 and associated initiator requests. In a similar manner, expander 100 may include an outbound table that maps outbound PHYs of outbound port 122 with corresponding targets 104 and associated targets identified in the initiator requests.

The receiver module 106 may be configured to allow communication between initiators 102 and targets 104. The receiver module 106 may communicate with an inbound PHY of inbound port 120 to manage communication with initiators 102 and with an outbound PHY of outbound port 122 to manage communication with targets 104. For example, receiver module 106 may receive initiator requests from initiators 102 which may include initiator wait time values 116 and specify requested targets. The initiator wait time values 116 may represent the length or amount of time an initiator has been waiting for access to the requested target specified in the request. The receiver module 106 can receive commands from initiators 102 to request to store and access data on storage resources of targets 104 and forward these commands to the particular targets. The receiver module 106 can receive responses from targets 104 that may include data and then forward the responses to the requesting initiators 102. The requests can include an open address frame (OAF) which is a SAS connection request frame that can include wait time values representing a length of time the requests have been waiting to access the specified target. In one example, the wait time values from the request can be an arbitration wait time (AWT) pan of OAF and SAS protocol. Although one expander 100 is shown in FIG. 1, a SAS fabric can include multiple expanders such that receiver module 106 can communicate with an expander that is in communication with an inbound PHY of inbound port 120 and with another expander that is in communication with an outbound PHY of outbound port 122.

The timer module 108 may be configured to include timers 112 to generate total wait time values 118 which can be used to assess how long initiator requests have been waiting to access specified targets. For example, the initiators 102 can be assigned timers 112 which can generate total wait time values 118 representing length of time that a particular initiator has been waiting to access a specified requested target. The timers 112 may be initialized with wait time values comprising user-defined wait times 114 and initiator request wait time values 116. The initiator request wait time values 116 can originate from the initiator requests which were sent from initiators 102. The user-defined wait time values 114 correspond to a particular priority level. The higher the user-defined wait time values 114, the higher the priority level. The arbitration module 110 is configured to give initiator requests having higher user-defined wait time values 114 a higher priority from among other initiators requesting access to the same target. The timer module 108 can include a priority table comprising user-defined wait time values 114 corresponding to particular inbound PHYs of inbound port 120. The priority table can associate or map initiator requests to particular inbound PHYs of an inbound port 120 and therefore particular user-defined wait time values 114. In this way, initiator requests can be assigned particular user-defined wait time values which have a corresponding priority. The total wait time value 110 can comprise a 16-bit counter, for example. The user-defined wait time values 114 can be selected 10 prevent reaching the maximum value of the 16-bit counter and to prevent locking out lower priority initiators.

The timer module 108 may provide a user with functionality to enter or modify the content of the priority table including user-defined wait time values 114 and associated inbound PHYs of inbound port 120. For example, expander 100 may provide a user interface to allow a user to enter user-defined wait time values 114 and assign them to particular PHYS of inbound port 120. The use interface can include a command line interface (CLI), graphical user interface (GUI) or other means of providing information to expander 100. The expander 100 can include management software to manage the priorities of the table. The management software can support vendor specific serial management protocol (SMP) commands such as SMP REPORT PHY PRIORITY TABLE and SMP CONFIGURE PHY PRIORITY TABLE to modify the priority information of the table.

The arbitration module 110 may include an arbitration process that may be configured to select an initiator request having the highest total wait time value 118 from among initiator requests requesting the same targets. As explained below in further detail, expander 100 may be configured to allow user to set priorities for each initiator in the fabric. The expander 100 may allow a user to specify user-defined wait time values 114 to particular initiators such that the expander may give higher priority to initiators having the highest total wait time values 118. In this manner, expander 100 may give initiators with higher wait total time values 118 higher priority over initiators with lower total wait time values from among other initiators contending for the same target resources.

To illustrate operation, assume that there are first and second initiators 102 coupled to expander 100 and intend to access targets 104 which have storage resources comprising a single ported hard drive. The first and second initiators 102 send a request to expander 100 for the same storage resource at the exact same time. The arbitration process of arbitration module 110 can then arbitrate between the first and second initiators requests and determine which initiator request is to be granted access to the requested storage resource. The arbitration module 110 can track the length of time that an initiator request has been waiting to access a specified target. The time can be tracked using a total wait time value 118 where a request with a higher wait time is provided with a connection to the specified target whereas a request having a lower wait time value may have to wait for the other request to complete before accessing the target. This may be known as least-recently used arbitration fairness and it is in this way fairness may be achieved on a SAS fabric.

In another example, expander 100 may allow users to set priorities for each initiator in the SAS fabric. When expander 100 receives an initiator request from an initiator 102, the expander can route the request to an outbound PHY of outbound port 122 corresponding to the requested target so that the request can reach the requested target. The initiator request may include en initiator wait time value 116 to indicate how long the initiator has been arbitrating for the connection to the particular target. A SAS fabric may include multiple expanders forming a path between initiator and target. Each expander in the path may add an additional wait time to the initiator generated wait before forwarding the initiator request to the next hop in the path to indicate how long that expander had to arbitrate before it found an available outbound PHY on outbound port 122. When two initiators contend for the same outbound PHY of outbound port 122, the total wait time (initiator wait time+expander wait time) for each request may be used to determine which initiator wins the arbitration and is granted a connection to the target. By increasing the expander-calculated wait time value for higher priority initiators over lower priority ones, the expander can help assure that when requests contending for the same target resources, higher priority initiators can be granted access to resources an increased percentage of the time.

The expander 100 may be coupled to initiators 102 and targets 104 through physical interconnections, which may be cables or hardwired interconnections. The two ends of a physical interconnection may be referred to as ports. The expander 100 may include a plurality of ports referred to as expander ports. Expander ports may be coupled to initiator ports and target ports through the physical interconnections, in some examples, initiators 102, expanders 100 and targets 104 may be installed in a blade enclosure. For example, the blade enclosure may include one or more blade bays for receiving blade servers, array controllers and an interconnect bay for receiving expander 102. In examples, the storage drive bays may be included in a separate storage enclosure. The SAS fabric of FIG. 1 shows one expander 100 for connecting two initiators 102 to two targets 104. However, it should be understood that this configuration is for illustrative purposes and that a different number of devices can be employed to implement the techniques of the present application.

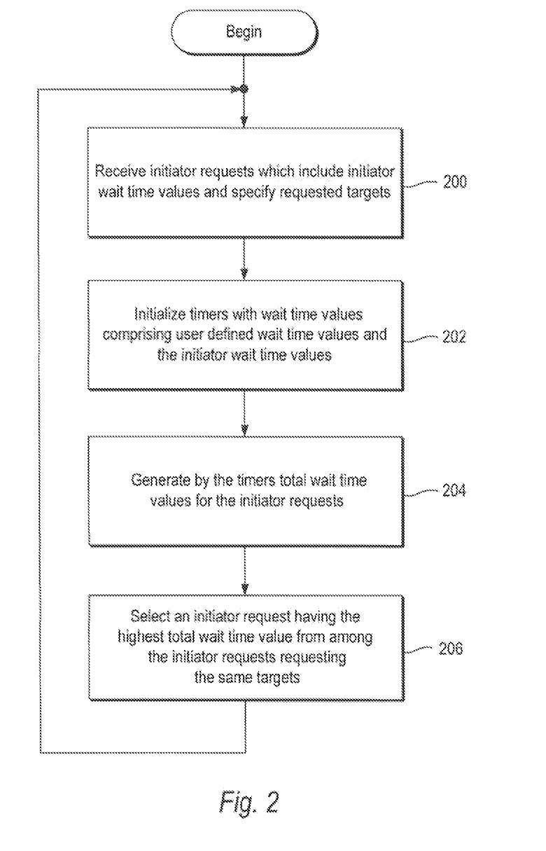

FIG. 2 is an example process flow diagram of a method of operating a SAS expander 100.

To illustrate, in one example, it can be assumed that expander 100 has a plurality of inbound PHYs associated with inbound port 120 and that the expander has a user interface to allow users to assign different priorities to each inbound PHY. The priorities can include different user-defined wait times 114 where higher time values correspond to higher priorities for initiators corresponding to the particular inbound PHY of inbound port 120. For example, the priority technique can include three levels of priority values: high, medium and low. However, it should be understood that other prioritization configurations may be used. The expander 100 can provide a user interface to allow a user to map the priority values to user-defined wait time values 114. The user-defined wait time values 114 can include fixed time increment values. The priority technique can be in the form of a priority table such as the priority table (Table 1) shown below:

TABLE 1

| Inbound PHY Identifier | User-defined wait time value |
|---|---|
| 0 | X |
| 1 | X |
| 2 | Y |
| 3 | Y |
| 4 | Z |
| 5 | Z |

To illustrate, it can be further assumed that inbound port 120 comprises six inbound PHYs (0 through 5) with corresponding identifiers and user-defined wait time values 114, as shown in Table 1. The user-defined wait time values 114 may be measured in milliseconds or microseconds. In one example, the priority technique may map a high priority to an increment X microseconds, a medium priority to an increment Y microseconds and a low priority to an increment Z microseconds where X>Y>Z. The priorities (i.e. additional user-defined wait time increment) for each initiator coupled to expander 100 may be stored in the expander in the form of the priority table (Table 1) for quick lookup. The priority table (Table 1) can provide the additional user-defined wait time values 114 that may be added to the wait time from initiators 102 when the initiator requests are first received by expander 100 on a particular inbound PHY of inbound port 120 and before the arbitration process of arbitration module 110 starts.

The method may begin at block 200, where expander 100 receives initiator requests which can include initiator wait time values 116 and specify requested targets. For example, to illustrate, it can be further assumed that there are two initiator requests being generated by initiators 102 requesting storage resources of targets 104. The first initiator request is received by expander 100 at inbound port 120 and is associated with an inbound PHY having identifier ‘0’. According to the priority table (Table 1), the inbound PHY having identifier “0” is associated with a user-defined wait time value of “X”. The first initiator request can include an initiator wait time 116 and specify a particular resource of targets 104. The second initiator request is received by expander 100 at inbound port 120 and is associated with an inbound PHY having identifier “2”. According to the priority table (Table 1), the inbound PHY having identifier “2” is associated with a user-defined wait fine value of “Y”. The second initiator request can include an initiator wait time 116 and specify storage resource of targets 104. in other words, first and second initiator requests are requesting to access the same resources of target 104. It should be understood that other examples are possible such as a different number of requests from different initiators. For example, there can be three requests for the same resources originating from three different initiators.

At block 202, expander 100 initializes timers 112 with wait time values that include user-defined wait time values 114 and initiator wait time values 116. Continuing with the example above, based on the priority table (Table 1), the first request can assigned a user-defined wait time value of “X” while the second request can been assigned a user-defined wait time value of “Y”. The time value of “X” is larger than the time value of “Y” and therefore the arbitration process may give the first request a higher priority over the second request when accessing the same target. The timer module 108 can assign one of the timers 112 to the first request which will be initialized with a user-defined wait time value 114 of “X” and with the initiator wait time value 116 from the first request in a similar manner, timer module 108 can assign one of the timers 112 to the second request which will be initialized with a user-defined wait time value 114 of “Y” and with the initiator wait time value 116 from the second request.

At block 204, expander 100 generates total wait times values 118 for the initiator requests. For example, timers 112 associated with respective initiator requests can generate respective total wait time values 118. Continuing with the example above, the first initiator request was assigned a higher wait time value compared to the second initiator request. The timer module 108 can generate a total wait time 118 for the first request which will be higher than the total wait time for the second request,

At block 206, expander 100 selects an initiator request having the highest total wait time value 118 from among the initiator requests requesting the same targets 104. Continuing with the example above, the first and second initiator requests are requesting the same resources of targets 104. The higher total wait time 118 of the first request corresponds to a higher priority than the total wait time of the second request. Accordingly, the arbitration process of arbitration module 110 may provide the first request access to the resources of the requested target because it has the highest total wait time compared to the second request which was requesting the same target. In some examples, expander 100 may include an outbound table that can map outbound PHYS of outbound port 122 to corresponding targets 104 and associated targets identified in the initiator requests. In this case, receiver module 106 may route the selected request to a corresponding outbound PHY of outbound port 122 which may be connected to the requested target. Once expander 100 has processed the initiator requests processing can proceed back to block 200 where it can continue to wait to receive additional initiator requests for processing by expander.

In another example, the SAS fabric may include additional expanders (not shown) connected between expander 100. In this case, expander 100 may forward the initiator request to the next or subsequent expander. The forwarded request may include the total wait time 118 generated by timer module 108. In this manner, the priority technique of expander 100 can be forwarded to the next expander without it having to have knowledge of the priority technique. In other example, the SAS fabric may include additional expanders (not shown) connected between expander 100 and initiators 102. In another example, to prevent starvation and live-lock conditions, the priority technique can include a rule specifying that the total wait time including the additional user-defined wait added for the priority technique may not exceed a threshold. For example, in a 16 bit counter example, the threshold value may be set to 0x8FF, of course the threshold may be set to other values as appropriate.

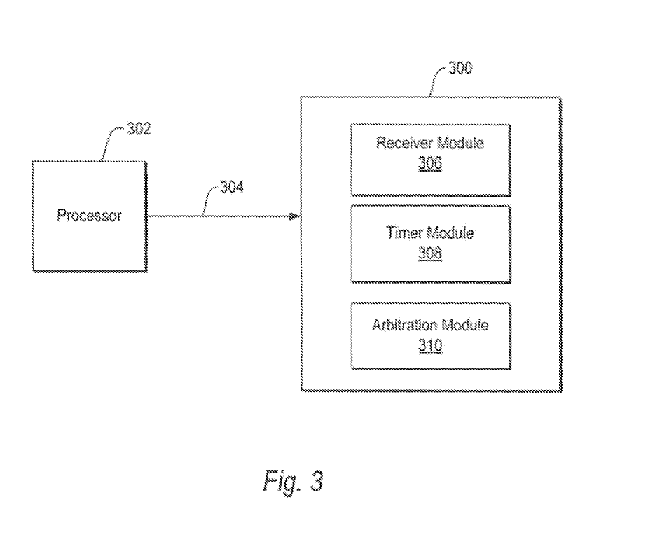

FIG. 3 is an example block diagram showing a non-transitory, computer-readable medium that stores code for operating a SAS expander. The non-transitory, computer-readable medium is generally referred to by the reference number 300 and may be included in SAS expander 100 of the SAS fabric described in relation to FIG. 1. The non-transitory, computer-readable medium 300 may correspond to any typical storage device that stores computer-implemented instructions, such as programming coda or the like. For example, the non -transitory, computer-readable medium 300 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 302 generally retrieves and executes the instructions stored in the non transitory, computer readable medium 300 to operate the SAS expander in accordance an example. In an example, the tangible, machine-readable medium 300 can be accessed by the processor 302 over a bus 304. A first region 306 of the non-transitory, computer-readable medium 300 may include receiver module functionality as described herein. A second region 308 of the non-transitory, computer-readable medium 300 may include timer module functionality as described herein. A third region 310 of the non-transitory, computer-readable medium 300 may include arbitration module functionality as described herein.

Although shown as contiguous blocks, the software components can be stored in any order or configuration. For example, if the non-transitory, computer-readable medium 300 is a hard drive, the software components can be stored in non-contiguous, or even overlapping, sectors.

What is claimed is:

1. A SAS expander comprising:
a receiver module to receive initiator requests which include initiator waif time values and specify requested targets;
a timer module having timers to generate total wait time values representing length of time the initiators having been waiting for the specified requested targets, wherein the timers are to be initialized with wait time values comprising the initiator request wait time values and user-defined wait time values; and
an arbitration module to select an initiator request having the highest total wait time value from among the initiator requests requesting the same targets.

2. The expander of claim 1, wherein the arbitration module is further configured to route the selected initiator request to an outbound PHY associated with the requested target.

3. The expander of claim 1, wherein the user-defined wait time venues correspond to priority levels wherein higher wait time values correspond to higher priority levels.

4. The expander of claim 1, wherein the timer module comprises a table of the user-defined wait time values corresponding to inbound PHYs and the initiator requests.

5. The expander of claim 1, wherein the initiator requests comprise connection requests that comprise open address frame SAS commands.

6. A method or operating a SAS expander comprising:
receiving initiator requests which include initiator wait time values and specify requested targets;
initializing timers with wait time values comprising user fined wait time values and the initiator wait time values;
generating by the timers total wait times values for the initiator requests; and
selecting an initiator request having the highest total wait time value from among the initiator requests requesting the same targets.

7. The method of claim 6, further comprising routing the selected initiator request to an outbound PHY associated with the requested target.

8. The method of claim 6, wherein the user-defined wait time values correspond to priority levels wherein higher wait time values correspond to higher priority levels.

9. The method of claim 6, further comprising providing a table comprising the user-defined wait time values corresponding to inbound PHYs and the initiator requests.

10. The method of claim 6, wherein the initiator requests comprise connection requests that comprise open address frame SAS commands.

11. A non-transitory computer computer-readable medium having computer executable instructions stored thereon to operate a SAS expander, the instruction are executable by a processor to:
receive initiator requests which include initiator wait time values and specify requested targets;
initialize timers with wait time values comprising user-defined wait time values and the initiator wait time values;
generate by the timers total wait times values for the initiator requests; and
select an initiator request having the highest total wait time value from among the initiator requests requesting the same targets.

12. The computer readable medium of claim 11 further comprising instructions that if executed cause a processor to:
route the selected initiator request to an outbound PHY associated with the requested target.

13. The computer readable medium of claim 11 further comprising instructions that if executed cause a processor to:
provide user access to modify a table comprising the user-defined wait time values corresponding to inbound PHYS and the initiator requests.

14. The computer readable medium of claim 11 further comprising instructions that if executed cause a processor to:
provide user access to modify the user-defined wait time values which correspond to priority levels wherein higher wait time values correspond to higher priority levels.

15. The computer readable medium of claim 11 further comprising instructions that if executed cause a processor to:
forward the selected initiator request as a connection request that comprises an open address frame SAS command to a subsequent expander.
